(19) United States
(12) Patent Application Publication
(10) Pub. No.: US 2015/0063520 A1
(43) Pub. Date: Mar. 5, 2015

(54) Nuclear Reactor Consuming Nuclear Fuel that Contains Atoms of Elements Having a Low Atomic Number and a Low Mass Number

(71) Applicant: Clean Nuclear Power LLC, Lugano (CH)

(72) Inventors: Yogendra Narain Srivastava, Lugano (CH); Allan Widom, Lugano (CH)

(21) Appl. No.: 14/372,424

(22) PCT Filed: Jan. 10, 2013
(86) PCT No.: PCT/IB2013/050218

§ 371 Date: Jul. 15, 2014

(30) Foreign Application Priority Data
Jan. 16, 2012 (IT) GE2012A000004

(51) Int. Cl. G21C 1/00

(52) U.S. Cl. CPC G21C 1/00
USPC 376/347

(57) ABSTRACT

The invention relates to a reactor for consuming a nuclear fuel that contains atoms of elements having a low atomic number (Z) and a low mass number (A), wherein the nuclear reactor (1) comprises a vessel (2) containing a reaction chamber (3). This reaction chamber (3) is topped and sealed by a sealed container (4), and contains the nuclear fuel, which comprises a colloidal mixture capable of producing Ultra Low Momentum Neutrons (ULMNs) by using electromagnetic radiations (5).

In its most general aspect, the present invention relates to a nuclear reactor for consuming nuclear fuel that contains atoms of elements having a low atomic number Z and a low mass number A. In addition to that, a method for igniting and controlling this reactor is also described.

In case of a nuclear accident, it is well known that one of the dangers of a nuclear reactor employing Uranium or Plutonium (high Z and A elements) is intimately tied to the very long periods of time in which harmful products of resulting nuclear reactions remain radioactive by emitting biologically hazardous radiations. For the same reason, the disposal of radioactive waste products produced during normal operations of these reactors requires complex and costly operations requiring long-term disposal sites.

This problem has been faced by NASA contractors in 2000, and the results coming out from this research have been recently made publicly available (18 Jul. 2011) in the NASA Technical report NASA/CR-2003-212169—“Advanced Energetics for Aeronautical Applications” (see Section 3.1.5.3, pg. 45-48). NASA identifies this new generation of nuclear reactors by using the term “Proton Power Cells.” NASA contractors (University of Illinois and Lattice Energy LLC) have measured an excess heat ranging from 20% to 100% employing a thin film (about 300 angstroms) of Nickel, Titanium and/or Palladium loaded with hydrogen as nuclear fuel. The metallic film was immersed in an electrochemical system with 0.5 to 1.0 molar Lithium sulfates in normal water as the electrolyte. To explain the reaction mechanism, Dr. George Miley (University of Illinois) hypothesized the fusion of 20 protons with five atoms of Nickel-58 by creating an atom of a super-heavy element (A=310); this super-heavy atom rapidly should decay by producing stable fission elements and heat in the metal film.

More relevant excess heat in Nickel powder reacting with gaseous hydrogen is described in the international patent application PCT/IT2008/000532 (WO 2009/125444 A1) to Pascucci and Rossi. In this patent application, it is hypothesized that under moderate temperature and pressure conditions, a proton (H⁺) can cross the Coulomb barrier, and fuse with an atom of Nickel by starting well-known decay reactions that produce excess heat.

In both cases, the inventors are unable to provide satisfactory explanations about the absence of high-energy radiation products: In the case of production of heavy elements, the presence of products having a relatively long half-life is expected but during Rossi's experiments, no high energy radiation has been measured during reactor stable operation. Moreover, both the mechanism of heavy element synthesis and the mechanism of fusion between protons and Nickel atoms under moderate conditions hypothesized respectively by Miley and Rossi lack scientific support.

On the contrary, the model described by Allan Widom and Lewis G. Larsen in the patent U.S. Pat. No. 7,893,414 B2 (applicant: Lattice Energy LLC) can explain the above-mentioned phenomena by using well-known models and interactions.

The main point of Widom-Larsen model is the production of radiation renormalized heavy electrons, which have multiple functions in the reactions:
(i) The electrons plus collective low frequency electromagnetic energy catalyze the production of ultra low momentum neutrons (ULMN) by weak interactions. These neutrons can be captured in nanoparticle target materials such as Palladium, Nickel or Lithium by starting the decay reactions producing nuclear radiations.
(ii) The electrons convert high-energy radiation into lower energy radiation such as infra-red or soft X-ray which form the excess heat from nuclear reactions.
   The first point allows the explanation of the occurrence of nuclear reaction under moderate temperature and pressure conditions without violating Coulomb's law or without accelerating atoms at a speed somewhat smaller than light speed necessary to produce super-heavy elements. The second point allows the explanation of the small quantity of radiation measured during the experiments and the presence, outside Rossi's reactor, of peaks of high-energy radiation only at the beginning and at the end of the operations, as measured by Prof. Francesco Celani (Istituto Nazionale di Fisica Nucleare—INFN—Frascati) during the experiment of 14 Jan. 2011 (see http://22passi.blogspot.com/2011/08/celani-risponde-sulla-misura-dei-gamma.html). Indeed, during the reactor transitions, the production of heavy electrons is reduced or stopped; hence gamma rays can come out from the reactor without being converted in lower energy radiations (heat and soft X-rays).

Another important aspect observed by Allan Widom and Lewis G. Larsen regards the production of heavy electrons: the heavy electrons are produced on a metallic substrate surface. This phenomenon involves the surface area of the metallic substrate, and can be thereby magnified by increasing the surface area if the nuclear fuel employs a metallic powder having adequate grain sizes.

In all the above-mentioned experiments, it was necessary to supply gaseous hydrogen into a reactor chamber requiring a hydrogen tank and/or an electrolysis system. The presence of the hydrogen tank can constitute a hazard in some applications such as automotive and/or home installations.

The present invention aims to solve these and other problems by providing a nuclear reactor for consuming nuclear fuel that preferably contains atoms of elements having a low atomic number Z and a low mass number A.

In addition to that, the present invention aims to solve these and other problems by providing a method for igniting and controlling a nuclear reactor consuming nuclear fuel that preferably contains atoms of elements having a low nuclear charge and atomic number.

The main idea of the present invention is the consumption of nuclear fuel that consists of a colloidal mixture of metallic powder in water.

Further advantageous features of the present invention are the subject of the attached claims.

The features of the invention are specifically set forth in the claims annexed to this description; such characteristics will be clearer from the following description of a preferred and non-exclusive embodiment shown in annexed drawings, wherein:

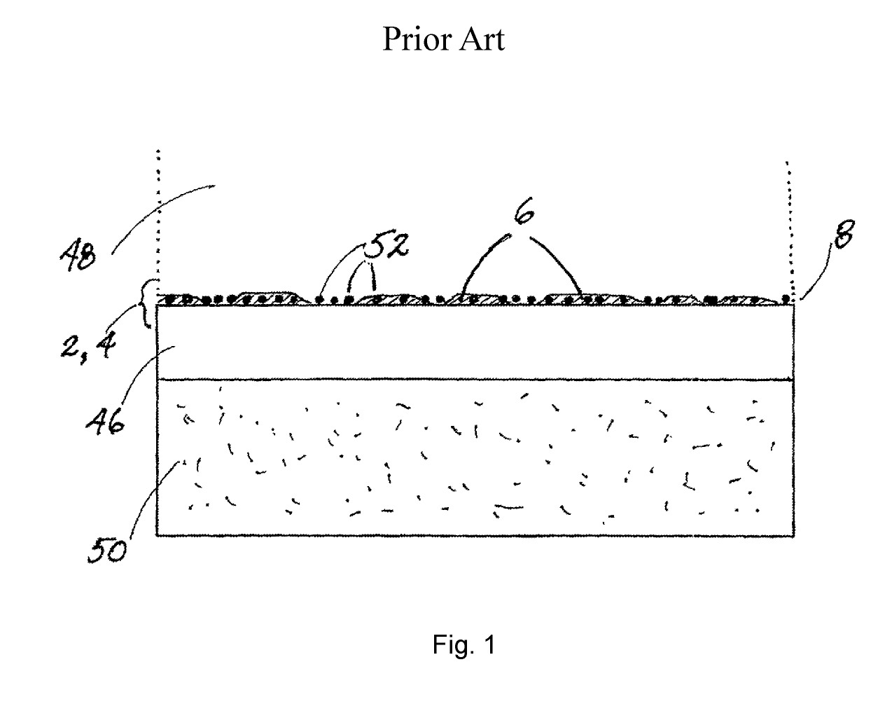

FIG. 1 shows a side view of the reactor described in the prior art document U.S. Pat. No. 7,893,414 B2 (FIG. 22 of the U.S. Pat. No. 7,893,414 B2 patent);

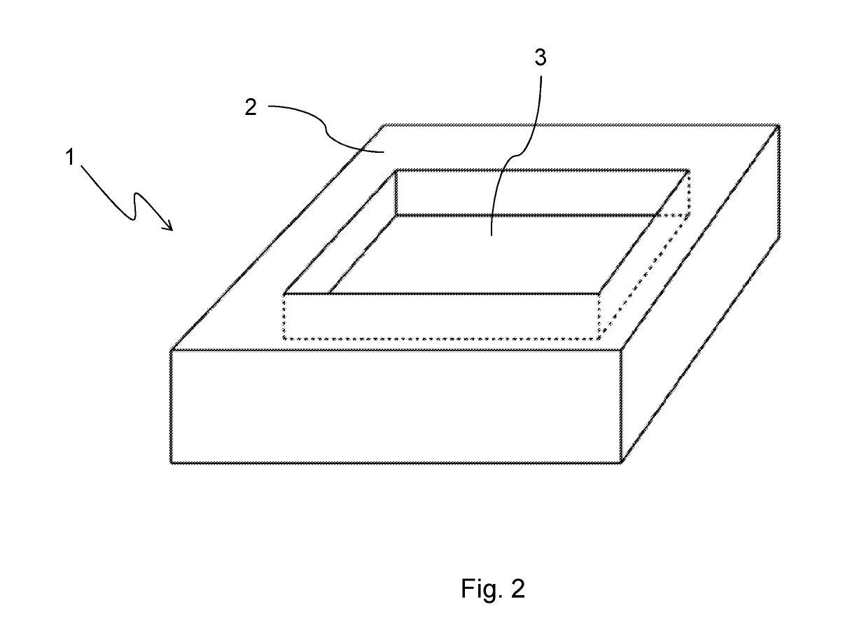

FIG. 2 shows a perspective view of the reactor according to the present invention;

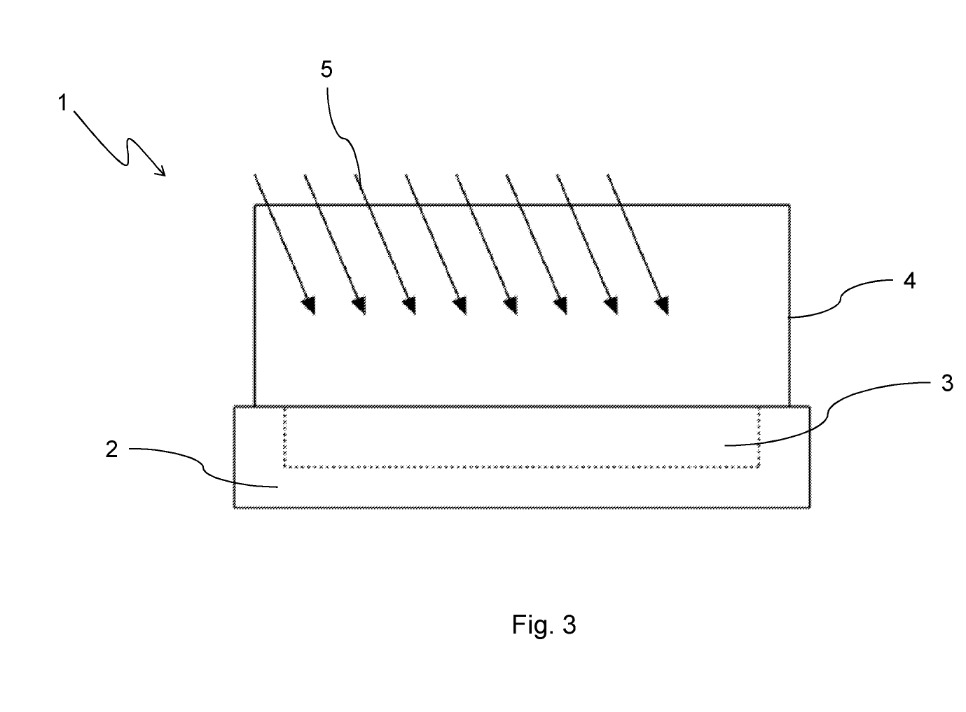

FIG. 3 shows a front view of the reactor of FIG. 2.

By referring to the drawings above, FIGS. 2-3 show the preferred embodiment that comprises a nuclear reactor 1 using a nuclear fuel (not shown in the attached figures).

The nuclear reactor 1 comprises a vessel 2, preferably box-shaped, containing a reaction chamber 3, which is topped and sealed by a sealed container 4; the latter is coupled hermetically with the vessel 2.

The vessel 2 is made of metal, preferably lead; the reactor's material is very important, since it must supply the following tasks: shielding internally produced radiations, in order to avoid dispersion of high-energy radiations; converting remaining high-energy radiations produced by the reactions into heat, in order to increase the efficiency of the reactor 1; transferring heat from the reaction chamber 3 to outside of the reactor 1.

The reaction chamber 3 is preferably a shallow trough, and contains the nuclear fuel. The nuclear fuel comprises a colloidal mixture of metallic powder in water. The colloidal mixture fills completely the reaction chamber 3, and a volume defined by the sealed container 4 above the reaction chamber 3 contains water vapor at saturated vapor pressure. The water could be deionized, although some ions are expected to be produced as soon as the nuclear reactions begin on the metallic powder surfaces of the colloidal mixture used in this invention. A dilute Lithium Li⁺ X⁻ ionic solution would be more efficient in creating a possible Lithium cycle arising from the ULMN within the metal. Powders of inexpensive Nickel of approximately micron or submicron size would be efficient if the radiation creating the heavy electrons is in the optical frequency range. Other metals such as Titanium or Palladium can be used in the colloidal mixture, and they would work well but are quite expensive for fuel burning in commercial applications. Per mole, Nickel is less expensive than Titanium or Palladium by perhaps four orders of magnitude. The colloid should be fairly dense, perhaps a finite fraction of close packing.

In accordance with the invention, the radius of the grains has to be similar and comparable to the wavelength of electromagnetic radiation 5 necessary to produce heavy electrons. These electromagnetic radiation 5 are produced by a radiation source (not shown in the attached figures), such as a wood's lamp, a laser source, an antenna, or similar means, which may be placed inside or outside the sealed container 4, in order to reduce the thermal stress of the radiation source. For this reason, the sealed container 4 can be partially or totally made of a material that is transparent to the electromagnetic radiations 5 irradiated by the radiation source.

Inside the colloidal mixture, the water located within the spaces between the metallic powder grains of the colloid is ordered, and the contact between water and the metal grains produces metallic hydrides on the grains' surfaces. The electric dipole moments of the water molecules tend to be parallel. This ordered interfacial water tends to carry a negative charge because the protons from the molecules tend to be pushed into the metal forming a metallic hydride in the neighborhood of the grain's surfaces. The surface metallic hydrides give rise to surface plasma oscillations, also known as surface plasmons or polaritons (SP) capable of extracting and storing the energy from the incident beam of electromagnetic energy.

The metallic hydrides have a central role in the production of heavy electrons, since they provide electrons that increase their mass (energy) due to the electromagnetic radiation 5 being absorbed. Indeed, the absorption of electromagnetic radiations 5 causes a relativistic effect by increasing the electrons' energy. When the electron energy reaches the threshold value of 2.531×mₑ, where mₑ is the electron mass, a heavy electron and a proton combine together producing a neutron n and a neutrino vₑ (see Eq. 1). According to Einstein's mass-energy equivalence, the electron has to absorb 0.7823 MeV of radiation energy in order to increase its mass 1.531 times.

0.782 MeV+e⁻+H⁺→n+vₑ (1)

The reacting proton it is provided by the water (continuous medium) injecting a hydrogen atom into the metal leaving the proton in the metal near the metal-water surface and leaving an electron in the water near the metal-water surface.

The neutrons produced in this way have extraordinary low kinetic energy and thereby low velocity (approaching zero), and are called Ultra Low Momentum Neutrons (ULMN). ULMNs have smaller energy than cold neutrons, so that they are suitable to be captured by narrow fuel nuclei, since they have extremely long quantum-mechanical wavelengths that are on the order of one to ten microns. The great size of their wave function is the source of endows ULMN with very large absorption cross-sections; it enables them to be rapidly absorbed by different nuclear fuel nuclei located anywhere within distances of up to a micron.

In order to optimize better the fuel nuclear fuel consumption with an optical radiation source during the reaction, the size of the metallic grains of the colloidal mixture should preferably have an average radius of size of ˜0.1 micron. In this way, there will be optical hot spots (intense speckle patterns) on the metallic surfaces producing the heavy electrons.

In Eq. 2, a neutron absorption event is described.

n+_{Z}^{A}X→^{A+1}_{Z}X (2)

If the metal powder of metallic colloid contains Nickel-64, the neutron absorption events produce Nickel-65 atoms as in Eq. 3.

n+₂₈⁶⁴Ni→₂₈⁶⁵Ni (3)

The Nickel-65 is a radioisotope, and decays by beta minus decay as in Eq. 4. This decay reaction has a heat of reaction (Q-value) of 2.138 MeV, and emits gamma radiations.

₂₈⁶⁵Ni→₂₉⁶⁵Cu+e⁻+ v̅ₑ̅+2.138 MeV (4)

In Eq. 4 e⁻ and v̅ₑ̅ represent respectively an electron and an electron antineutrino.

Therefore, a Ni-64 decay reaction comprises one neutron absorption event and one beta minus decay by releasing a net excess energy of Q=1.356 MeV as in Eq. 5. Eq. 5 describes an ideal clean nuclear reaction, which transmutes a stable Nickel atom Ni-64 into a stable copper atom Cu-65 with the unstable intermediate Nickel nucleus Ni-65 decaying in a short time period of about two and one-half hours (Ni-65 half-life=2.517 hours, Ni-65 life-time=3.631 hours).

0.782 MeV+e⁻+H⁺→n+vₑ

n+₂₈⁶⁴Ni→₂₈⁶⁵Ni→₂₉⁶⁵Cu+e⁻+ v̅ₑ̅+2.138 MeV (5)

This excess energy is enormous compared with the one of a chemical reaction, and can be used for large-scale energy production. One mole of electrons has the Faraday charge of N_{A}e=F=9.648534×10⁴ Coulomb so that chemical energies of the order of one electron volt have a molar energy N_{A} (1 eV)=F×1 volt=96.48534 KiloJoule; whereas nuclear energies of one mega electron volt have a molar energy scale N_{A} (1 MeV)=9.648534×10¹⁰ Joule. One reacting Nickel-64 nucleus can produce a net energy of Q=1.356 MeV per nuclei. The molar energy is thereby Q=1.308×10¹¹ Joule/Mole. If all the Nickel-64 atoms present in one mole of Nickel-64 react at the same time by capturing N_{A} neutrons, the net power produced is P=(Q/τ)=(1.308×10¹¹ Joules/Mole)/(1.307×10⁴ sec); i.e. P≈10 MegaWatt/Mole.

If the metal powder of the nuclear fuel contains Nickel-58 (68.077% of the natural abundance of Nickel), another possible decay reaction can be used to produce Cobalt by transmutation. When a Nickel-58 atom absorbs a neutron, it becomes a Nickel-59 atom (see Eq. 6).

n+₂₈⁵⁸Ni→₂₈⁵⁹Ni (6)

Nickel-59 can decay into stable Cobalt-59 by electron capture decay. This reaction releases 1.073 MeV, but due to the long half-life (76000 years), Nickel-59 is unsuitable for energy production purposes (the mean net power produced by one mole in the half-life of Ni-59 is about 0.011 Watt). However, once the neutrons are being produced at a steady rate, repeated neutron absorptions can produce up to Ni-65 which beta decays to Cu-65 with a half life of about 2.51 hours. Therefore, the beta decay from unstable Nickel to stable copper takes place within a few hours. If the neutrons are produced in steady state, large numbers of nuclear reactions become possible. For this reason, it would be convenient to modify the isotopic composition of the natural abundance of Nickel through an enrichment process (e.g. high speed centrifugation), in order to increase advantageously the presence of Nickel-64 in the nuclear fuel. In this way, the mean net power per mole produced by the consumption of the nuclear fuel into the nuclear reactor 2 can be increased.

Other useful reactions can involve Palladium and Titanium.

If the metal powder of the nuclear fuel contains Palladium, Palladium-108 (26.460% of the natural abundance of Palladium) and Palladium-110 (11.720% of the natural abundance of Palladium) can be involved in decay reactions.

A Palladium-108 decay reaction comprises one neutron capture event and one beta minus decay by releasing a net excess energy of 334 KeV (see Eq. 7). The neutron capture event produces Palladium-109, which is a radioisotope, and the subsequent beta minus decay produces stable Silver-109.

0.782 MeV+e⁻+H⁺→n+vₑ

n+₄₆¹⁰⁸Pd→₄₆¹⁰⁹Pd→₄₇¹⁰⁹Ag+e⁻+ v̅ₑ̅+1.116 MeV (7)

If all the Palladium-108 atoms present in one mole of Palladium-108 react at the same time by capturing N_{A} neutrons, the mean net power produced in the lifetime of Palladium-109 (19.770 hours) is about 452.791 KW. This amount of specific power makes this decay reaction interesting for energy production purposes.

A Palladium-110 decay reaction comprises one neutron capture event and two beta minus decays by releasing a net excess energy of 2.472 MeV (see Eq. 8). The neutron capture event produces unstable Palladium-111, then the first beta minus decay produces unstable Silver-111, and the second beta minus decay produces stable Cadmium-111.

0.782 MeV+e⁻+H⁺→n+vₑ

n+₄₆¹¹⁰Pd→₄₆¹¹¹Pd→₄₇¹¹¹Ag+e⁻+ v̅ₑ̅+2.217 MeV

₄₇¹¹¹Ag→₄₈¹¹¹Cd+e⁻+ v̅ₑ̅+1.037 MeV (8)

If all the Palladium-110 atoms present in one mole of Palladium-110 react at the same time by capturing N_{A} neutrons, the mean net power produced by the first beta decay in the lifetime of Palladium-111 (33.83 minutes) is about 68.211 MW, whereas the mean net power produced by the second beta decay in the lifetime of Silver-111 (10.8 days) is about 107.227 KW.

It is possible to appreciate that Palladium-110 can release a large amount of energy in a short time. This makes Palladium-110 decay reaction suitable to ignite other decay reactions like Nickel-64 decay reaction, which employs a less expensive element.

If the metal powder of the nuclear fuel contains Titanium, Titanium-50 (5.4% of the natural abundance of Titanium) can be involved in decay reactions.

A Titanium-50 decay reaction comprises one neutron capture event and one beta minus decay by releasing a net excess energy of 1.692 MeV (see Eq. 9). The neutron capture event produces unstable Titanium-51, and then the beta minus decay produces stable Vanadium-51.

0.782 MeV+e⁻+H⁺→n+vₑ

n+₂₂⁵⁰Ti→₂₂⁵¹Ti→₂₃⁵¹V+e⁻+ v̅ₑ̅+2.474 MeV (9)

If all the Titanium-50 atoms present in one mole of Titanium-50 react at the same time by capturing a neutron, the mean net power produced by the beta decay in the lifetime of Titanium-51 (8.32 minutes) is about 327.029 MW.

It is easy to understand how the control of a so powerful reaction is critical to successfully operate the nuclear reactor 1 without melting it. To control the nuclear reaction, the colloidal mixture comprises a moderator.

The moderator can control the power produced by varying the production rate of ULMNs. One possible method involves interaction between gamma ray and steam produced by vaporizing the water (continuous medium) of the colloidal mixture. However, the reaction can always be slowed down by making the colloid in more dilute lumps. However, reaction rates that are too high are rarely an insoluble problem for the collective weak interaction system.

Another effect due to the presence of heavy electrons is the shielding effect. Heavy electrons can scatter a high photon radiation into several low energy radiations by limiting the quantity of high-energy radiation emitted by the nuclear reaction. In this way, almost all the gamma rays produced by the reaction can be converted into infrared radiations in a very high efficient way. Infrared radiations produces heat, which can be easily transformed into electricity by using well-known means like steam turbines, Stirling engines, or the like.

In order to produce enough excess energy, it is necessary to have the possibility to produce a large amount of ULMNs. The expected ULMN production rates may be numerically estimated in the following manner. The effective energy W of an electron of mass m within the metal in a fluctuating electric field E due to the surface plasma frequency Ω is given by

$$W = \sqrt{{m}^{2} {c}^{4} + {c}^{2} {p}^{2}} = m {c}^{2} β = m {c}^{2} \sqrt{1 + \frac{{E}^{2}}{{E}_{0}^{2}}} , \\ β = \sqrt{1 + \frac{P}{{P}_{0}}} wherein {P}_{0} = \frac{c}{4 π} {E}_{0}^{2} , \\ {E}_{0} = \frac{m c Ω}{e} = ( \frac{m {c}^{2}}{e} ) \frac{2 π}{Λ} and P = \frac{c}{4 π} {E}^{2} . \qquad ( 10 )$$

(i) The electron momentum is p.
(ii) Ω is the surface plasma frequency and ΩΛ is light speed c.
(iii) The most simple derivation of Eq. (10) is obtained by relating the rate of change of the electron momentum p to the electric field force eE and time averaging over the surface plasma cycles.
(iv) The reference intensity is P₀≈(2.736334×10¹⁰ watt/Λ²).
(v) For experimentally measured radio frequency surface plasma oscillations, Λ˜100 cm yielding P₀˜3×10⁶ watt/cm².
(vi) The incident electromagnetic intensity is Pᵢ.
(vii) The intensity P=APᵢ defines the hot spot amplification A.
(viii) If Pᵢ˜300 watt/cm², then

$$β = \sqrt{1 + A ( \frac{{P}_{i}}{{P}_{0}} )} ∼ \sqrt{1 + A \times {10}^{- 4}} .$$

(ix) The threshold energy to create a neutron via Eq. 1 corresponds to β₀≈2.531
(x) If A˜5×10⁶ is obtained, then β˜20 far above threshold.

The ULMN production rate ω̅₂≈v(β−β₀)² yields the final estimate of the nuclear reaction rate per unit grain surface area, which is ω̅₂˜10¹⁵ Hz/cm².

To start the nuclear reactor 1, a method for igniting and controlling this reactor 1 is now described. The method comprises the following steps:
a) filling the reaction chamber 3 with a metallic powder containing Nickel and/or Palladium and/or Titanium;
b) filling the reaction chamber 3 with water by creating the colloidal mixture of metallic powder in water;
c) sealing the reaction chamber 3 with the sealed container 4,
d) waiting until the volume defined by the sealed container 4 above the reaction chamber 3 contains water vapor at saturated vapor pressure;
e) irradiating the colloidal mixture by using the electromagnetic radiations 5;
f) controlling the nuclear reactor (1) by adjusting the incident radiation intensity.

From the foregoing it can be appreciated that the reactor according to the present invention can be exploited for the production electric power, thermal energy, or other forms of useful energy (i.e. mechanical).

It is understood that variants of the nuclear reactor 1 and/or variants of the method for igniting and controlling the nuclear reactor 1 still fall within the scope of the following claims.

1. A nuclear reactor (1), comprising a vessel (2) and a reaction chamber (3) located in the vessel (2) for containing a nuclear fuel, wherein said nuclear reactor (1) comprises a radiation source suitable for providing electromagnetic radiations (5) to the nuclear fuel contained in the reaction chamber (3).

2. The nuclear reactor (1) according to claim 1, wherein the nuclear fuel comprises a colloidal mixture capable of producing Ultra Low Momentum Neutrons (ULMNs) when subjected to electromagnetic radiations (5).

3. The nuclear reactor (1) according to claim 2, wherein the nuclear fuel comprises atoms of elements with a low atomic number (Z) and a low mass number (A).

4. The nuclear reactor (1) according to claim 1, wherein the nuclear fuel comprises one or more of the following elements: Lithium (Li), Nickel (Ni), Copper (Cu), Palladium (Pd), Titanium (Ti), or isotopes of said elements.

5. The nuclear reactor (1) according to claim 1, wherein the nuclear fuel comprises a colloidal mixture with an aqueous solution (continuous medium) and a metal powder dispersed therein, having particles of dimensions in a range from 10⁻⁶ to 10⁻⁹ m.

6. The nuclear reactor (1) according to claim 1, wherein the nuclear fuel comprises particles with a radius similar to the wavelength of electromagnetic radiations (5).

7. The nuclear reactor (1) according to claim 6, wherein the wavelength of the electromagnetic radiations is on the order of 1 to 10 microns.

8. A nuclear fuel reaction process wherein the nuclear fuel comprises elements having a low atomic number (Z) and a low mass number (A), comprising the steps of:
a. preparing a colloidal mixture of metallic powder comprising one or more of the following elements: Lithium, Nickel, Copper, Palladium, Titanium, or isotopes thereof;
b. irradiating the colloidal mixture by using an electromagnetic radiations (5).

9. The nuclear fuel reaction process according to claim 8, wherein said reaction process is controlled by varying the intensity of the electromagnetic radiations (5).

10. The nuclear fuel reaction process according to claim 9, wherein the wavelength of the electromagnetic radiations (5) is substantially similar to a radius of grains of the metallic powder in the colloidal mixture.
